(19) United States
(12) Patent Application Publication
(10) Pub. No.: US 2003/0110466 A1
(43) Pub. Date: Jun. 12, 2003

(54) Method for the automatic generation of symbol tables of a real time computer

(76) Inventors: Eric Dricot, St Remy Les Chevreuse (FR); Christophe Gabreau, Neauphle Le Chateau (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/169,097

(22) PCT Filed: Jan. 11, 2001
(86) PCT No.: PCT/FR01/00087

(30) Foreign Application Priority Data
Jan. 14, 2000 (FR) 00 00476

(51) Int. Cl. G06F 9/44

(52) U.S. Cl. 717/100

(57) ABSTRACT

The method of the invention consists in making an airborne computer (1), initially placed in off-operational conditions, send its symbols file, when it is initialized, to a validation bench (6) which thus builds up a dictionary of symbols for each computer that can be used. In operational mode, the computer to which the bench is connected sends its identity to this bench. This enables the bench to associate the corresponding data dictionary with the computer. Application to the validation of executable software for a flight management system (FMS).

The present invention relates to a method for the automatic generation of symbol tables of a real-time computer.

The tweaking and validation of airborne computers of the flight management system (FMS) type necessitates the installation of investigation means, both on the aircraft and in the laboratory (for preparation and maintenance), providing access to a number of internal data (especially data characteristic of the nominal operation of the computer). In the case of FMS (flight management system) computers for aircraft such as the Airbuses A320 to A340, these investigation means are the tool “SPATIAAL.” This is a tool for the display of data internal to the computer and is included in a simulator connected to the computer which is itself connected to its usual hardware environment. The simulator sends the commands for the display of the internal parameters through an ARINC bus to the computer and, in return, the computer sends out corresponding data on a bus dedicated to in-flight trials. Similarly, the simulator may send out commands to modify internal parameters. However, for security reasons, commands of this type are reserved solely for the selection of the gains look-up tables or of the gains whose effects have been preliminarily validated in the laboratory.

In order that these internal parameters may be referenced by the tool, they must be fully described in a data dictionary. Their description comprises especially the following: their mnemonic code, the physical address of the variable, the identification of the processor of the computer, the type of parameters in question, the framing of their values etc.

In presently used systems, the data dictionaries must be generated from files (known as “symbol tables” or “maps”) coming from executable software production chains (compilation chains, editor links, etc). Inasmuch as the physical addresses of the variables may change (for example following a change in the type of aircraft, computer, etc) the generation of a data dictionary must be started again for each new version of an executable software program. Furthermore, the “maps” files cannot be directly exploited by the tool and must therefore be the object of appropriate processing (namely the shaping of the information according to a precise “grammar”).

An object of the present invention is a method for the automatic generation of symbol tables that does not necessitate the generation of a data dictionary at each modification of the corresponding executable software programs, thus preventing the potential errors associated with the required consistency of these executable software programs and of the data dictionaries as well as preventing the need to develop information-processing software programs for the shaping of this information according to the grammar used, and also preventing changes or modifications in the executable software preparing chains.

For each new computer to be identified, the method according to the invention comprises a step for setting up a data dictionary, when the computer is initialized, under secured external conditions, preferably in off-operating conditions, in making the computer provide the list of the symbols that its software programs may use, sending the file corresponding to this list on an external line, advantageously a dedicated line, to means of access to data of the computer which store it and then, in the operating phase of operation of a specified computer, making this computer send its identity to a simulator, making the simulator retrieve the file corresponding to this specified computer and deducing the data dictionary associated with this computer from this file, It is then possible to carry out the process of validation of the executable software programs to be validated.

The present invention will be understood more clearly from the following detailed description of a mode of implementation, taken as a non-restrictive example and illustrated by the appended drawing, in which:

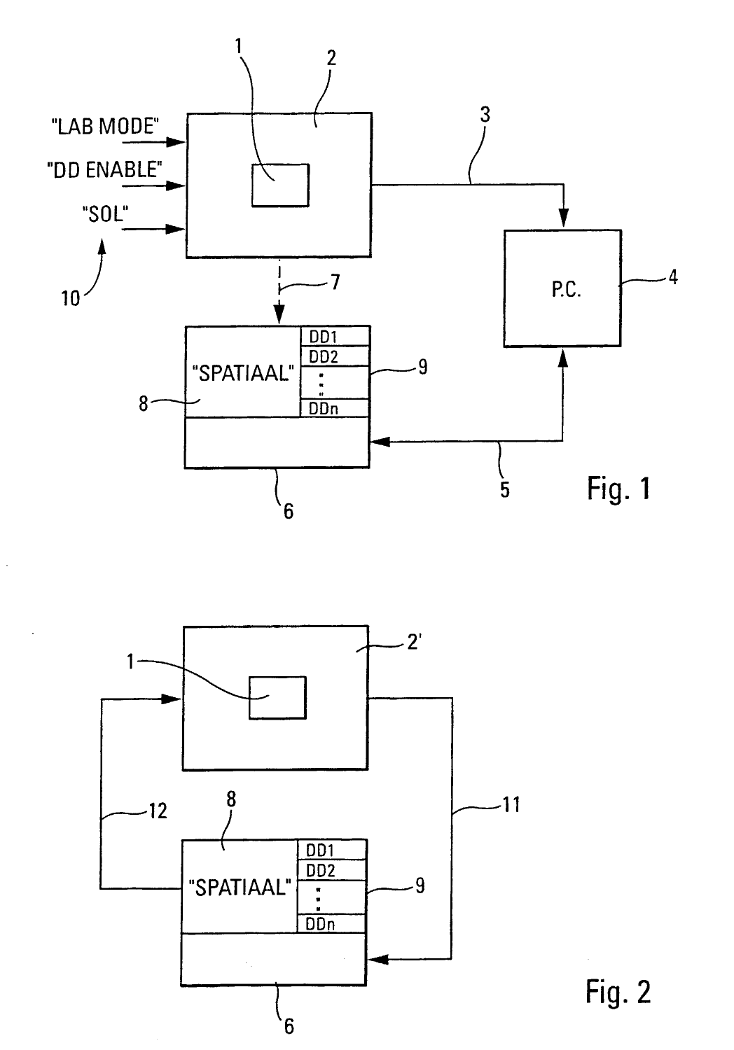

FIG. 1 is a block diagram of the devices used for the generation of a data dictionary corresponding to a computer, according to the method of the invention, and

FIG. 2 is a block diagram of the devices used for the implementation of the method of the invention, in operational mode, during the validation of the executable software programs.

The present invention is described here below with reference to aircraft computers, but it is understood that it is not limited to this application alone and that it can be implemented for other types of computers.

The device shown schematically in FIG. 1 is generally used on the ground, in the laboratory, to produce a data dictionary (also called a symbol dictionary) corresponding to a type of airborne computer.

The computer 1, to which the method of the invention relates, is contained in its usual hardware environment 2. The output of the computer, at which the files of the symbol tables appear, is connected by a line 3 to a maintenance tool 4. This maintenance tool is for example a maintenance PC. The computer 4 is furthermore connected by a line 5 (for example an Ethernet type of line) to a validation bench (or simulator) 6. In a variant, as shown in a dashed line, the computer 1 may be directly connected to the bench 6 by a line 7 (maintenance line). The bench 6 comprises a part 8 which is the above-mentioned “SPATIAAL” function (tool for the display of internal data of the computer 1) and a part 9 consisting of several zones for the recording of data dictionaries, each of the zones being assigned to the data dictionary of a particular computer. Naturally, some of these zones may be vacant, after the method of the invention has been executed by all the computers liable to be used at that point in time, with a view to the subsequent recording of other data dictionaries for other future computers. Similarly, if certain computers subsequently become obsolete, the corresponding dictionaries may be erased from the part 9.

In order to be able to produce a data dictionary, the computer 1 receives configuration parameters 10. These parameters are: a “LABMODE” command, a “DD-ENABLE” command and “SOL” data on conditions external to the ground standard (such as “NOSEGEARPRESSED”). “LABMODE” indicates the fact that the computer is mounted on a laboratory validation bench and “DD-ENABLED” authorizes the automatic generation of the data dictionary.

When the computer 1 is powered on, and the two commands mentioned above are in the active state, the computer reads the data on the external conditions and initiates the generation of the data dictionary, which is sent to the bench 6 through the line 3, the PC 4 and the line 5 (or, as the case may be, on the line 7). The data dictionary is registered in the corresponding zone of the part 9.

FIG. 2 relates to the second part of the implementation of the method of the invention. The second part takes place in operational mode, i.e. when the computer 1 is on board the aircraft for which it is designed, for laboratory trials and in-flight trials, when it is connected to its real hardware environment 2′. It is connected by a line 11 to the bench 6 and the function 8 of the bench 6 is connected by a line 12 to the computer 1.

When the computer 1 is powered on (the validation bench 26 is then powered), this computer sends the bench its “part numbers” as well as the parameters to be displayed through the line 11. The bench 6 is therefore in a position to automatically compare these references, which it receives from the computer, with the different references of the data dictionaries stored in the different zones of the part 9, and therefore to select the data dictionary associated with the executable software program being validated. Thus, the computer 1 is automatically recognized by the simulator (SPATIAAL function), without disturbing its operation in real-time.

1- Method for the automatic generation of symbol tables of a real-time computer comprising, for each new computer (1), a step for setting up a data dictionary, when the computer is initialized, under secured external conditions, in making the computer provide the list of the symbols that its software programs may use, sending the file corresponding to this list to means of access to data of the computer (6) which stores it (6) and then, in the operating phase of operation of a specified computer, making this computer send its identity to a simulator, making the simulator retrieve the file corresponding to this specified computer and deducing the data dictionary associated with this computer from this file.

2- Method according to claim 1, characterized in that the file is sent to the bench through an external line (5) and an auxiliary computer (4).

3- Method according to claim 2, characterized in that the line is an Ethernet type line.

4- Method according to claim 1, characterized in that the file is sent directly to the bench (7).

5- Method according to one of the above claims, characterized in that the setting up of the data dictionary is done off operational mode.

6- Method according to one of the above claims, characterized in that the computer is an airborne computer and in that the access means are a bench for the validation of software executable by the computer.
